(19) United States
(12) Patent Application Publication
(10) Pub. No.: US 2024/0316561 A1
(43) Pub. Date: Sep. 26, 2024

(54) MICROFLUIDIC SUBSTRATE, MICROFLUIDIC CHIP AND ASSAY DEVICE

(71) Applicants: Beijing BOE Sensor Technology Co., Ltd., Beijing (CN); BOE TECHNOLOGY GROUP CO., LTD., Beijing (CN)

(72) Inventors: Bolin Fan, Beijing (CN); Le Gu, Beijing (CN); Yongjia Gao, Beijing (CN); Yingying Zhao, Beijing (CN); Li Yang, Beijing (CN); Huazhe Liu, Beijing (CN)

(73) Assignees: Beijing BOE Sensor Technology Co., Ltd., Beijing (CN); BOE TECHNOLOGY GROUP CO., LTD., Beijing (CN)

(21) Appl. No.: 18/579,562

(22) PCT Filed: Jul. 29, 2022
(86) PCT No.: PCT/CN2022/108894

§ 371 Date: Jan. 16, 2024

(51) Int. Cl. B01L 3/00

(52) U.S. Cl. CPC B01L 3/502792; B01L 2200/06; B01L 2300/0645; B01L 2400/0415

(57) ABSTRACT

Provided are a microfluidic substrate, a microfluidic chip, and an assay device. The microfluidic substrate includes: a base substrate; a conductive layer arranged on the base substrate, patterns of the conductive layer includes one or more electrode patterns and one or more trace patterns, an orthogonal projection of at least a portion of each trace pattern onto the base substrate is on one side of an orthogonal projection of a corresponding electrode pattern onto the base substrate with a minimum spacing of greater than or equal to 4 micrometers from an outer contour of the electrode pattern.

### TECHNICAL FIELD

The present disclosure relates to the field of microfluidic technology, in particular to a microfluidic substrate, a microfluidic chip and an assay device.

### BACKGROUND

A Microfluidic chip (Micro fluidic Chip) is a science and technology characterized primarily by manipulation of fluids in a microscale space. A digital microfluidic chip takes a droplet as a manipulation object, and controls the movement of the droplet through electric field force, thermal force, electrostatic force, etc. The technology is capable of controlling each individual droplet separately, and it requires a small amount of samples and reagents, has a simple structure, is convenient for large-scale integration, is more convenient for droplet manipulation, has controllable droplet size and shape, and has such advantages as miniaturization, integration, low cost, high sensitivity and high flexibility, so as to greatly speed up the movement, extraction, separation, mixing and detection of samples, and thereby showing great prospects in the fields of physics, chemistry, biology and medicine.

However, in the related art, the uncontrollable electrostatic neutralization during the use of the digital microfluidic chip or during the manufacturing process of a substrate thereof may cause the functional failure of the chip or the decrease in the handling accuracy of droplet, which finally results in such problems as a reduced yield of the chip at a client end, an increased manufacturing cost and a greatly reduced reliability at an application end.

### SUMMARY

The embodiments of the present disclosure provide a microfluidic substrate, a microfluidic chip and an assay device, so as to mitigate the phenomenon of device failure caused by static charges and thereby improve chip reliability.

The present disclosure provides the following technical solutions.

In a first aspect, an embodiment of the present disclosure provides a microfluidic substrate, including
a base substrate; and
a conductive layer arranged on the base substrate, where patterns of the conductive layer include one or more electrode patterns and one or more trace patterns, an orthogonal projection of at least a portion of each trace pattern onto the base substrate is on one side of an orthogonal projection of a corresponding electrode pattern onto the base substrate with a minimum spacing of greater than or equal to 4 micrometers from an outer contour of the corresponding electrode pattern.

Illustratively, an outer contour of each of at least a portion of the electrode patterns includes an arc portion, and a minimum spacing between an orthogonal projection of at least a portion of a corresponding trace pattern onto the base substrate and an orthogonal projection of the arc portion onto the base substrate is greater than or equal to 4 micrometers; and/or
an outer contour of each of at least a portion of the electrode patterns includes a sharp portion, and a minimum spacing between an orthogonal projection of at least a portion of a corresponding trace pattern onto the base substrate and an orthogonal projection of the sharp portion onto the base substrate is greater than or equal to 25 micrometers; and/or
an outer contour of each of at least a portion of the electrode patterns includes a linear portion, and a minimum spacing between an orthogonal projection of at least a portion of a corresponding trace pattern onto the base substrate and an orthogonal projection of the linear portion onto the base substrate is greater than or equal to 20 micrometers.

Illustratively, the electrode patterns include a plurality of first electrodes spaced apart from each other and a plurality of second electrodes spaced apart from each other, the trace patterns include a plurality of first traces, at least one of the first electrodes is coupled to at least one of the second electrodes via a corresponding one of the first traces.

Illustratively, the microfluidic substrate further includes:
a dielectric layer covering one side of the conductive layer away from the base substrate;
a hydrophobic layer covering one side of the dielectric layer away from the base substrate;
where an orthogonal projection of the hydrophobic layer onto the base substrate coincides with an orthogonal projection of the second electrode onto the base substrate, and an orthogonal projection of at least a portion of the first electrodes onto the base substrate is located outside orthogonal projections of the dielectric layer and the hydrophobic layer onto the base substrate, to enable the at least a portion of the first electrodes to be exposed to a surface of the microfluidic substrate.

Illustratively, the trace patterns further include one or more second traces, one end of each second trace is coupled to one of the second electrodes, and the other end thereof is a floating end.

Illustratively, the electrode patterns further include one or more third electrodes each located on one side of and spaced apart from the floating end.

Illustratively, the floating end is spaced apart from the third electrode by less than or equal to 20 micrometers.

Illustratively, the microfluidic substrate further includes a middle region and a peripheral region located at a periphery of the middle region, and the electrode patterns and the trace patterns are located in the middle region; the patterns of the conductive layer further include an outer-charge shielding region located at the peripheral region to surround the middle region.

Illustratively, a distance between the outer-charge shielding region and a peripheral edge of the base substrate is greater than or equal to 5-mm.

Illustratively, the patterns of the conductive layer further include: a charge neutralization region, an orthogonal projection of the charge neutralization region onto the base substrate is located in the middle region with a spacing from the orthogonal projection of the outer-charge shielding region onto the base substrate, the charge neutralization region includes a covering portion and an opening portion, a pattern of at least a part of the opening portion has a same shape as at least one electrode pattern and at least one trace pattern, and the covering portion covers at least an area in the middle region except the one or more electrode patterns and the one or more trace patterns, and the covering portion is insulated from at least a portion of the electrode patterns and the trace patterns.

Illustratively, the covering portion is spaced apart from the electrode patterns and the trace patterns that are insulated from the covering portion by a distance of greater than or equal to 25 micrometers.

Illustratively, an orthogonal projection of the charge neutralization region onto the base substrate is spaced apart from the orthogonal projection of the outer-charge shielding region onto the base substrate by a distance of greater than or equal to 20 micrometers.

Illustratively, the electrode patterns further includes a plurality of fourth electrodes disposed in a floating manner, the charge neutralization region is electrically connected to at least one of the fourth electrodes, and at least a part of the fourth electrodes is exposed to a surface of the microfluidic substrate.

Illustratively, at least one first electrode is a driving electrode for driving a droplet to move, at least one second electrode is a signal terminal electrode for applying an electric signal to the driving electrode.

In a second aspect, the present disclosure provides a microfluidic chip, including a first substrate and a second substrate arranged opposite to each other to form a cell, where a sample flow channel is formed between the first substrate and the second substrate, the above-mentioned microfluidic substrate is used as the first substrate.

In a third aspect, the present disclosure provides an assay device including the above-mentioned microfluidic chip.

The embodiments of present disclosure have the following beneficial effects.

In the microfluidic substrate, microfluidic chip and assay device provided by the embodiments of the present disclosure, the orthogonal projection of at least a portion of each trace pattern onto the base substrate in the conductive layer of the microfluidic substrate is on one side of the orthogonal projection of a corresponding electrode pattern onto the base substrate, and the minimum spacing between the orthogonal projection of at least a portion of each trace pattern onto the base substrate and the outer contour of the corresponding electrode pattern is greater than or equal to 4 micrometers. In this way, it is able to effectively prevent the electrostatic breakdown of critical parts in the microfluidic substrate, avoid the functional failure of the device due to electrostatic discharge, improve the yield of the microfluidic substrate, improve the reliability of the microfluidic chip at the application end, and reduce the manufacturing cost of the microfluidic chip.

### BRIEF DESCRIPTION OF THE DRAWINGS

FIG. 1 is a top view of a microfluidic substrate according to some embodiments of the present disclosure;

FIG. 2 is a schematic view showing patterns of a conductive layer in the microfluidic substrate according to some embodiments of the present disclosure:

FIG. 3 is a partial cross-sectional view of the microfluidic substrate in FIG. 1 along line A-A′;

FIG. 4 is a cross-sectional view of a partial structure of a microfluidic chip formed by the microfluidic substrate and another substrate arranged opposite to each other to form a cell according to some embodiments of the present disclosure;

FIG. 5 is a schematic view showing patterns of a charge neutralization region in the microfluidic substrate according to some embodiments of the present disclosure;

FIG. 6 is a schematic view showing the wiring of electrode patterns and trace patterns in a conductive layer according to some embodiments of the present disclosure:

FIG. 7 is a schematic diagram of a simulation model established in accordance with the embodiment of FIG. 6 and a topical integration Townsend growth factor distribution in the simulation model;

FIG. 8 illustrates is a schematic view showing the wiring of electrode patterns and trace patterns in the conductive layer according to some embodiments of the present disclosure; FIG. 9 is a schematic diagram of a simulation model established in accordance with the embodiment of FIG. 8 and a topical integration Townsend growth factor distribution in the simulation model;

FIG. 10 is a schematic view showing the wiring of electrode patterns and trace patterns in the conductive layer according to some embodiments of the present disclosure;

FIG. 11 is a schematic diagram of a simulation model established in accordance with the embodiment of FIG. 10 and a topical integration Townsend growth factor distribution in the simulation model;

FIG. 12 is a schematic view showing the wiring of electrode patterns and trace patterns in the conductive layer according to some embodiments of the present disclosure;

FIG. 13 is a schematic diagram of a simulation model established in accordance with the embodiment of FIG. 12 and a topical integration Townsend growth factor distribution in the simulation model;

FIG. 14 is a schematic view showing the wiring of electrode patterns and trace patterns in the conductive layer according to some embodiments of the present disclosure;

FIG. 15 is a schematic diagram of a simulation model established in accordance with the embodiment of FIG. 14 and a topical integration Townsend growth factor distribution in the simulation model;

FIG. 16 is a schematic view showing the wiring of electrode patterns and trace patterns in the conductive layer according to some embodiments of the present disclosure;

FIG. 17 is a schematic diagram of a simulation model established in accordance with the embodiment of FIG. 12 and a topical integration Townsend growth factor distribution in the simulation model;

FIG. 18 shows an enlarged view of a partial structure at a dashed box B in FIG. 2.

### DETAILED DESCRIPTION

In order to make the objects, the technical solutions and the advantages of the present disclosure more apparent, the present disclosure will be described hereinafter in a clear and complete manner in conjunction with the drawings and embodiments. Apparently, the following embodiments merely relate to a part of, rather than all of, the embodiments of the present disclosure, and based on these embodiments, a person skilled in the art may, without any creative effort, obtain the other embodiments, which also fall within the scope of the present disclosure.

Unless otherwise defined, any technical or scientific term used herein shall have the common meaning understood by a person of ordinary skills. Such words as “first” and “second” used in the specification and claims are merely used to differentiate different components rather than to represent any order, number or importance. Similarly, such words as “one” or “one of” are merely used to represent the existence of at least one member, rather than to limit the number thereof. Such words as “include” or “including” intends to indicate that an element or object before the word contains an element or object or equivalents thereof listed after the word, without excluding any other element or object. Such words as “connect/connected to” or “couple/coupled to” may include electrical connection, direct or indirect, rather than to be limited to physical or mechanical connection. Such words as “on”, “under”. “left” and “right” are merely used to represent relative position relationship, and when an absolute position of the object is changed, the relative position relationship will be changed too.

Before the detailed description on the embodiments of the present disclosure, it is necessary to describe the related art as follows.

In the related art, a microfluidic chip (Micro fluidic Chip) is a science and technology characterized primarily by manipulation of fluids in a micro-scale space, and has the ability to scale the basic functions in a biological, chemical, etc. laboratory to a chip having a few square centimeters, and is therefore called a Lab on a chip. Microfluidic chips mostly form a network of microchannels, with controllable fluids running through the entire system to achieve various functions in conventional chemical or biological laboratories. A digital microfluidic chip takes a droplet as a manipulation object, and controls the movement of the droplet through electric field force, thermal force, electrostatic force, etc. The technology is capable of controlling each individual droplet separately, and it requires a small amount of samples and reagents, has a simple structure, is convenient for large-scale integration, is more convenient for droplet manipulation, has controllable droplet size and shape, and has such advantages as miniaturization, integration, low cost, high sensitivity and high flexibility, so as to greatly speed up movement, extraction, separation, mixing and detection of samples, and thereby showing great prospects in the fields of physics, chemistry, biology and medicine.

Currently, a passive digital microfluidic chip is a mainstream chip solution in commercial digital microfluidic chip products due to its large cost advantage. The digital microfluidic chip has been widely used in a library preparation process, which has the characteristics of many kinds of reagents, complex temperature field and long process time, which undoubtedly requires high reliability of the chip.

Generally, the digital microfluidic chip includes an upper substrate and a lower substrate arranged opposite to each other to form a cell, and a sample flow channel is formed between the upper substrate and the lower substrate. Generally, the lower substrate includes a conductive layer, a dielectric layer and a hydrophobic layer, and the conductive layer mainly functions to form key members of the microfluidic substrate, and is provided with an electrode pattern and a trace pattern, for example, a driving electrode for driving the movement of a droplet and a signal line coupled to the driving electrode, etc.

In addition, in the case of the passive digital microfluidic chip, an FPC (flexible circuit board) or a probe may be used to apply an electric signal to the driving electrode. When the probe is used to apply a signal, a spring-loaded pin (also referred to as a pogo pin) may be arranged on the microfluidic substrate, and thereby a signal terminal electrode pattern may also be arranged on the conductive layer to be electrically connected to the spring-loaded pin, and the signal terminal electrode is coupled to the driving electrode via a signal line. For the purpose of enabling the probe to apply a signal, the signal terminal electrode is uncovered by the dielectric layer and the hydrophobic layer and is exposed to the outside, so as to facilitate the connection between the signal terminal electrode and the probe.

As compared with the manner of applying the electric signal using FPC (flexible circuit board), when the probe is used to apply the electric signal, it is able to omit a process of binding the flexible circuit board, so as to reduce the cost of the microfluidic substrate in a better manner. Furthermore, as a consumable, the digital microfluidic chip in which the electric signal is applied by using a probe may be operated and used without professional knowledge for users.

The lower substrate is formed by means of a multilayer stack of a conductive layer, a dielectric layer and a hydrophobic layer and by using a semiconductor process to realize the manufacture of a chip. According to different dielectric layers and hydrophobic layers, the assembly of the chip may need to be completed in different work stations and even different factories, in this process, the chip is liable to fail due to electrostatic discharge. This not only reduces the yield of the chip on a client end and increase the manufacturing cost, but also greatly reduces the reliability of the chip on an application end, thus limiting the further development of digital microfluidic chip.

Specifically, since the manufacturing process of a digital microfluidic chip is complicated, the electric field strength that can be endured by a dielectric layer is limited, and the working environment thereof is various, electrostatic discharge tends to occur during the use or manufacturing process of the chip, and when electrostatic discharge occurs in different processes, it may cause different problems. For example, before forming the dielectric layer, electrostatic discharge occurs on the lower substrate, it may lead to partial burn-up of the driving electrode of the chip. In case that the subsequent processes are all performed normally, it is still for the chip to achieve liquid driving, however, it may lead to a decrease in droplet manipulation accuracy which ultimately affects the biochemical test results of the chip. In case that the electrostatic discharge occurs after the completion of the dielectric layer, it may lead to the destruction of the dielectric layer, which directly resulting in that the droplet cannot be driven.

The uncontrollable electrostatic neutralization caused by any of the above-mentioned reasons may result in functional failure of the chip, or a decrease in droplet control accuracy, which finally leads to such problems as reduced yield of the chip at the client end, increased manufacturing costs and greatly reduced reliability at the application end.

In order to solve the above-mentioned problems, the embodiments of the present disclosure provide a microfluidic substrate, a microfluidic chip and an assay device, so as to mitigate the phenomenon of device failure caused by static charges and thereby improve chip reliability.

The microfluidic substrate may be used as a substrate in the microfluidic chip (e.g., a lower substrate), arranged opposite to another substrate (e.g., an upper substrate) to form a cell and thereby forming the microfluidic chip.

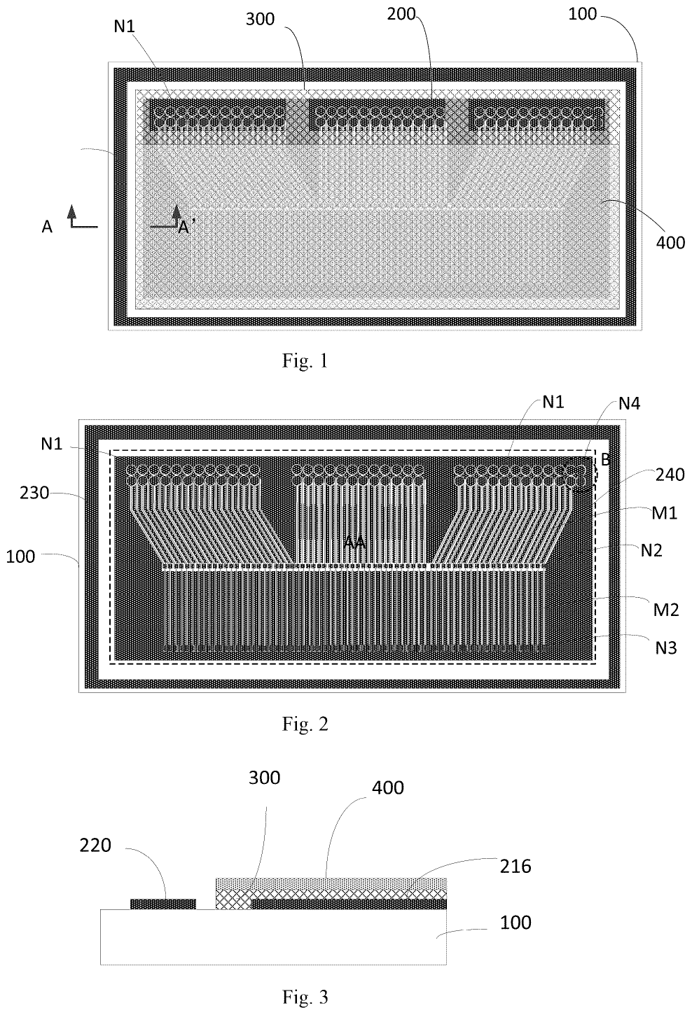

Referring to FIGS. 1-2, 6, 8 and 10, the microfluidic substrate includes a base substrate 100, and a conductive layer 200 arranged on the base substrate 100, patterns of the conductive layer 200 include one or more electrode patterns 210 and one or more trace patterns 220, an orthogonal projection of at least a portion of each trace pattern 220 onto the base substrate 100 is on one side of an orthogonal projection of a corresponding electrode pattern 210 onto the base substrate 100, and a minimum spacing d (shown in a position denoted by a dashed box in FIG. 6) between the orthogonal projection of at least a portion of each trace pattern 220 onto the base substrate 100 and an outer contour of the corresponding electrode pattern 210 is greater than or equal to 4 micrometers.

In the conductive layer 200 of the microfluidic substrate, the orthogonal projection at least a portion of each trace pattern onto the base substrate 100 is on one side of the orthogonal projection of the corresponding electrode pattern 210 onto the base substrate 100, and the minimum spacing d between the orthogonal projection of at least a portion of each trace pattern 220 onto the base substrate 100 and the outer contour of the corresponding electrode pattern 210 is greater than or equal to 4 micrometers. In this way, it is able to effectively prevent electrostatic breakdown between the trace pattern and the electrode pattern in the microfluidic substrate, protect critical parts in the microfluidic substrate, so as to avoid device functional failure due to electrostatic discharge, thereby to improve the yield of the microfluidic substrate, improve the reliability of the microfluidic chip at the application end and reduce the manufacturing cost of the microfluidic chip.

It should be appreciated that a specific shape of the electrode pattern 210 and a specific wiring manner of the trace pattern 220 in the above-mentioned schemes are not particularly defined herein, as long as the requirement on that the minimum spacing d between the electrode pattern 210 and the corresponding trace pattern 220 arranged on one side thereof is greater than or equal to 4 micrometers is met.

For a microfluidic substrate, the electrode pattern 210 may refer to any electrode pattern 210 on the substrate, e.g., an arbitrary electrode pattern such as a driving electrode for driving the movement of the droplet, and a signal terminal electrode for applying an electric signal to the driving electrode. The trace pattern 220 may also refer to any trace on the substrate, e.g., an arbitrary trace pattern such as a signal line connecting the driving electrode and the signal terminal electrode.

In order to better achieve the effect of avoiding the electrostatic breakdown, the present disclosure further provides a plurality of exemplary implementations of the minimum spacing d between the electrode pattern 210 and the corresponding trace pattern 220 arranged on one side thereof for different shapes of the electrode pattern 210.

FIG. 6 is a schematic view showing the partial wiring of the electrode patterns 210 and the trace patterns 220 on the microfluidic substrate in some exemplary embodiments of the present disclosure. As shown in FIG. 6, an outer contour of each of at least a portion of the electrode patterns 210 includes an arc portion 210a, and a minimum spacing d between an orthogonal projection of at least a portion of a corresponding trace onto the base substrate and an orthogonal projection of the arc portion 210a onto the base substrate 100 is greater than or equal to 4 micrometers.

When some electrodes of the electrode patterns 210 of each of which the outer contour includes the are portion 210a, when a corresponding trace runs through one side of the arc portion 210a, that is, when the corresponding trace runs adjacent to the corresponding arc portion 210a, the minimum spacing d between the trace and the arc portion 210a may be greater than or equal to 4 micrometers.

Taking FIG. 6 as an example, when the outer contour of the electrode is circular, elliptical, or any shape including an arc portion 210a that includes such as both a straight edge and an arc edge, the minimum spacing d between the electrode and a corresponding trace arranged on one side of the arc portion 210a thereof may be greater than or equal to 4 micrometers, so as to avoid the electrostatic breakdown phenomenon.

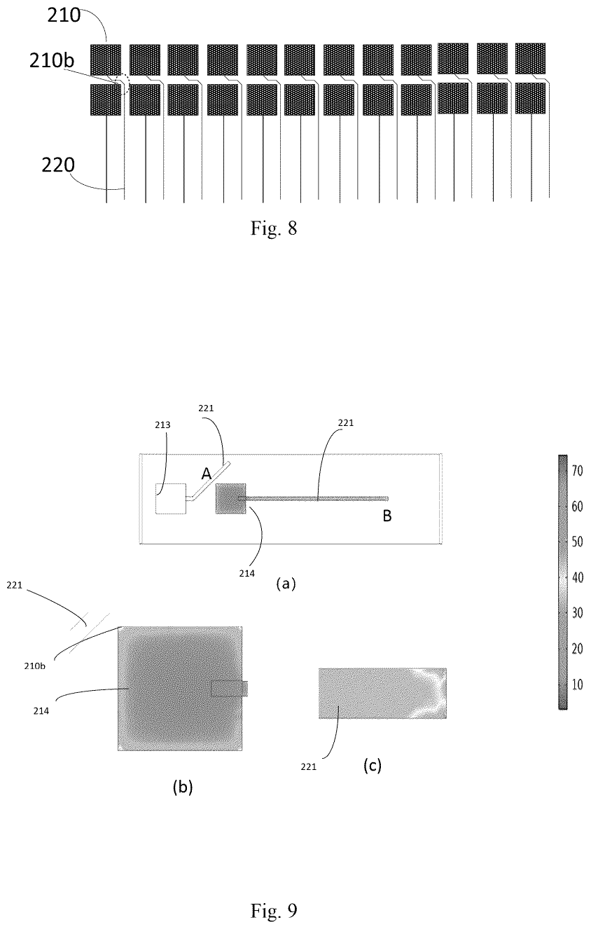

FIG. 8 is another schematic view showing the partial wiring of the electrode patterns 210 and the trace patterns 220 on the microfluidic substrate according to some exemplary embodiments of the present disclosure. As shown in FIG. 8, an outer contour of each of at least a portion of the electrode patterns 210 includes a sharp portion 210b, and a minimum spacing d between an orthogonal projection of at least a portion of a corresponding trace onto the base substrate and an orthogonal projection of the sharp portion 210b onto the base substrate 100 is greater than or equal to 25 micrometers.

When some electrodes of the electrode patterns 210 of each of which the outer contour includes the sharp portion 210b, when a corresponding trace runs through one side of the sharp portion 210b, that is, when the corresponding trace is adjacent to the sharp portion 210b, the minimum spacing d between the trace and the sharp portion 210b may be greater than or equal to 25 micrometers.

Taking FIG. 8 as an example, when the outer contour of the electrode is in the shape of a rectangle or the like including the sharp portion 210b, the minimum spacing d between the electrode and a corresponding trace arranged on one side of the sharp portion 210b may be greater than or equal to 25 micrometers, so as to avoid the electrostatic breakdown phenomenon.

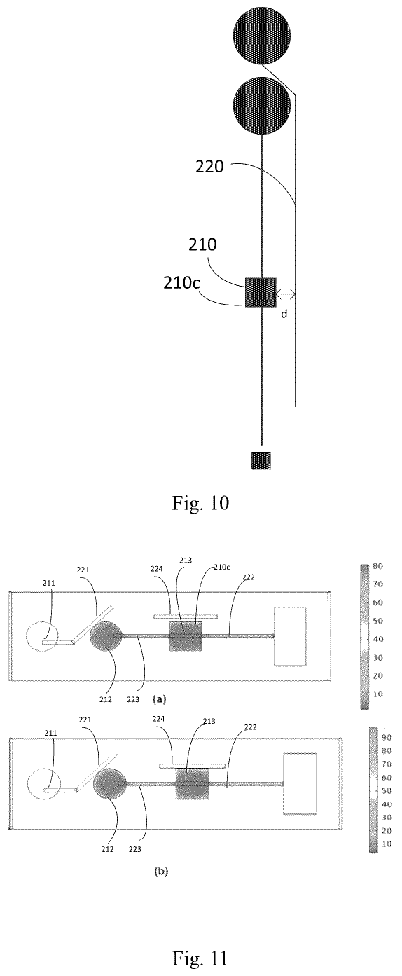

FIG. 10 is another schematic view showing the partial wiring of the electrode patterns 210 and the trace patterns 220 on the microfluidic substrate according to some exemplary embodiments of the present disclosure. As shown in FIG. 10, an outer contour of each of at least a portion of the electrode patterns 210 includes a linear portion 210c, and a minimum spacing d between an orthogonal projection of at least a portion of a corresponding trace onto the base substrate and an orthogonal projection of the linear portion 210c onto the base substrate 100 is greater than or equal to 20 micrometers.

When some electrodes of the electrode patterns 210 of each of which the outer contour includes the linear portion 210c, when a corresponding trace runs through one side of the linear portion 210c, that is, when the corresponding trace is adjacent to the linear portion 210c, the minimum spacing d between the trace and the linear portion 210c may be greater than or equal to 20 micrometers.

Taking FIG. 10 as an example, when the outer contour of the electrode is in the shape of a rectangle or the like including the linear portion 210c, the minimum spacing d between the electrode and a corresponding trace arranged on one side of the linear portion 210c may be greater than or equal to 20 micrometers, so as to avoid the electrostatic breakdown phenomenon.

In order to explain the above schemes more clearly, simulation result verification is performed below in conjunction with simulation models in several embodiments of the present disclosure.

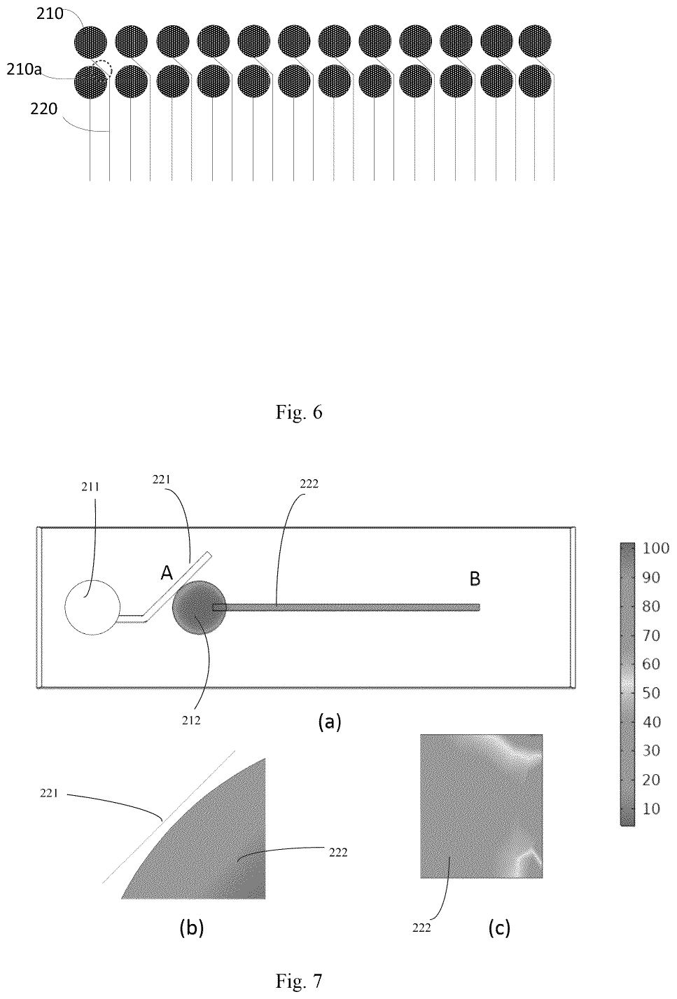

FIG. 7 shows a simulation model of a first embodiment shown in FIG. 6.

As shown in FIG. 7, in the simulation model, an outer contour shape of the electrode is a circle including an arc portion 210a, and the minimum spacing d between at least part of a corresponding trace and the arc portion is 4 micrometers. This simulation model is mainly used to verify the electrostatic breakdown between the trace and the electrode when the minimum spacing d between the arc portion of the electrode and the trace adjacent thereto is 4 micrometers.

Taking the simulation model shown in FIG. 7 as an example, the electrode patterns 210 may specifically include a first circular electrode 211 and a second circular electrode 212, the first circular electrode 211 is coupled to a first floating trace 221, and the second circular electrode 212 is coupled to a second floating trace 222, the first floating trace 221 is arranged on one side of an arc portion 210a of the second circular electrode 212 and has a minimum spacing d from the arc portion 210a, and the minimum spacing d is 4 μm (namely, at position A in Subfigure (a) in FIG. 7). Illustratively, a diameter of the electrode is 1 mm and a line width of the trace is 25 μm.

It is assumed that a rectangular outer box in the simulation model shown in Subfigure (a) in FIG. 7 is at a zero potential. It is assumed that the first circular electrode 211 and the first floating trace 221 are at a floating potential, and the second circular electrode 212 and the second floating trace 222 are electrostatic contact discharge regions, namely, assuming that static charges are introduced by the second circular electrode 212. Air is chosen as a medium.

A discharge breakdown condition may be represented by the following formula:

$${γ}_{i} ( exp ( {\int }_{0}^{D} N α ds ) - 1 ) = 1$$

where i is a secondary emission coefficient, N is a number density, a is a conversion Thomson growth/attenuation coefficient, s is an arc length along a particle trajectory, and D is a distance from a source boundary to any target boundary.

In the above formula, when the value on the left side of the formula is less than 1, discharge does not occur; otherwise, a continuous discharge occurs. It should be noted that the occurrence of discharge does not necessarily mean that an electrostatic breakdown occurs, and that irreversible device damage may only occur if a discharge current is large enough and the heat generated is sufficient. However, under the same voltage condition, a relative size of an integration Thomson growth coefficient obtained through this model reflects the probabilities of the occurrence of electrostatic breakdown at different positions. When an electrostatic voltage reaches a critical value, the device may be destroyed first at a position with a higher probability of electrostatic breakdown.

Subfigure (b) in FIG. 7 shows the integration Townsend growth coefficient at point A in Subfigure (a) in FIG. 7, and Subfigure (c) in FIG. 7 shows the Townsend growth coefficient at point B in Subfigure (a) in FIG. 7. By comparing the integration Townsend growth coefficient at point A with the Townsend growth coefficient at point B, it is derived that the probability of electrostatic breakdown at point B is significantly greater than that at point A. That is, the electrostatic discharge point may be located at the end of the second floating trace 222, and the first circular electrode 211 is intact, thereby to effectively avoid the electrostatic breakdown occurring at a portion of the electrode adjacent to the trace, and prevent the electrode from being damaged.

FIG. 9 shows a simulation model of a second embodiment in FIG. 8.

As shown in FIG. 9, in the simulation model, an outer contour shape of the electrode is a rectangle including a sharp portion 210b, and the minimum spacing d between at least part of a corresponding trace and the sharp portion 210b is 25 micrometers. This simulation model is mainly used to verify the electrostatic breakdown between the trace and the electrode when the minimum spacing d between the sharp portion 210b of the electrode and the trace adjacent thereto is 25 micrometers.

Taking the simulation model shown in FIG. 9 as an example, the electrode patterns 210 may specifically include a first rectangular electrode 213 and a second rectangular electrode 214, the first rectangular electrode 213 is coupled to a first floating trace 221, and the second rectangular electrode 214 is coupled to a second floating trace 222, the first floating trace 221 is arranged on one side of a sharp portion 210b of the second rectangular electrode 214 and has a minimum spacing d from the sharp portion 210b, and the minimum spacing d is 25 μm (namely, at position A in Subfigure (a) in FIG. 9). Illustratively, the rectangular electrode has a size of 1 mm*1 mm, and a line width of the trace is 25 μm.

It is assumed that a rectangular outer box in the simulation model shown in Subfigure (a) in FIG. 9 is the zero potential point. It is assumed that the first rectangular electrode 213 and the first floating trace 221 are each at a floating potential, and the second rectangular electrode 214 and the second floating trace 222 are electrostatic contact discharge regions, namely, assuming that static charges are introduced by the second rectangular electrode 214. Air is chosen as a medium.

Subfigure (b) in FIG. 9 shows the integration Thomson growth coefficient at point A in Subfigure (a) in FIG. 9, and Subfigure (c) in FIG. 9 shows the Thomson growth coefficient at point B in Subfigure (a) in FIG. 9. By comparing the integration Townsend growth coefficient at point A with the Townsend growth coefficient at point B, it is derived that the probability of electrostatic breakdown at point B is significantly greater than that at point A. That is, according to the simulation results, when the minimum spacing d between the sharp portion 210b of the second rectangular electrode 214 and the first trace is greater than 25 micrometers, the first floating trace 221 has no effect on the integration Thomson growth coefficient of a surface of the second rectangular electrode 214, and a value of the integration Thomson growth coefficient at the end of the second floating trace 222 is greater than a value of the integration Thomson growth coefficient on the second rectangular electrode 214, that is, the probability of the electrostatic charge neutralization occurring at the end of the second floating trace 222 is greater at this time.

FIG. 11 shows a simulation model of a third embodiment shown in FIG. 10.

As shown in FIG. 11, in the simulation model, an outer contour shape of the electrode is a rectangle including a linear portion 210c, and the minimum spacing d between at least part of a corresponding trace and the linear portion 210c is 20 micrometers. This simulation model is mainly used to verify the electrostatic breakdown between the trace and the electrode when the minimum spacing d between the sharp portion 210b of the electrode and the trace adjacent thereto is 20 micrometers or more.

Taking the simulation model shown in FIG. 11 as an example, the electrode patterns 210 may specifically include a first circular electrode 211, a second circular electrode 212 and a first rectangular electrode 213, the first circular electrode 211 is coupled to a first floating trace 221, a signal trace 223 is connected between the second circular electrode 212 and the first rectangular electrode 213, the first rectangular electrode 213 is further coupled to a second floating trace 222, and a third floating trace 224 is arranged on one side of a linear portion 210c of the first rectangular electrode 213, and there is a minimum spacing d between the third floating trace 224 and the linear portion 210c. Illustratively, the rectangular electrode has a size of 1 mm*1 mm, a diameter of the circular electrode is 1 mm, and a line width of the trace is 25 μm. It is assumed that a rectangular outer box in the simulation model shown in Subfigure (a) in FIG. 11 is at a zero potential. It is assumed that the first circular electrode 211 and the first floating trace 221 are at a floating potential, and the second circular electrode 212 is an electrostatic contact discharge region, namely, assuming that static charges are introduced by the second circular electrode 212. Air is chosen as a medium.

Subfigure (a) in FIG. 11 shows the distribution of the integration Thomson growth coefficient when a minimum spacing d between the third floating trace 224 and the linear portion 210c of the first rectangular electrode 213 is 20 micrometers. Subfigure (b) in FIG. 11 shows the distribution of the integration Thomson growth factor when a minimum spacing d between the third floating trace 224 and the linear portion 210c of the first rectangular electrode 213 is 10 micrometers. As is apparent from Subfigure (b) in FIG. 11, the smaller the minimum spacing d between the third floating trace 224 and the linear portion 210c of the first rectangular electrode 213, the greater the probability that electrostatic discharge occurs on one side of the first rectangular electrode 213 adjacent to the third floating trace 224 than on the other side. As can be seen from Subfigure (a) in FIG. 11, when the minimum spacing d between the third floating trace 224 and the linear portion 210c of the first rectangular electrode 213 is 20 micrometers, the integration Thomson growth coefficient of the surface of the first rectangular electrode 213 shows a centrosymmetric distribution, namely, the third floating trace 224 has no effect on the electrostatic discharge condition of the first rectangular electrode 213.

The above are simulation verifications on several wiring cases of the electrode patterns 210 and trace patterns 220, and it is derived from the above verification results that there is a minimum spacing d between the orthogonal projection of at least a portion of the trace onto the base substrate and the orthogonal projection of the are portion 210a onto the base substrate 100, and the minimum spacing d is greater than or equal to 4 micrometers. Furthermore, there is a minimum spacing d between the orthogonal projection of at least a portion of the trace onto the base substrate and the orthogonal projection of the sharp portion 210b onto the base substrate 100, and the minimum spacing d is greater than or equal to 25 micrometers. In addition, there is a minimum spacing d between the orthogonal projection of at least a portion of the trace onto the base substrate and an orthogonal projection of the linear portion 210c onto the base substrate 100, and the minimum spacing d is greater than or equal to 20 micrometers. In this way, it is able to effectively mitigate the phenomenon of electrostatic breakdown of the critical parts on the microfluidic substrate, so as to protect the critical parts on the microfluidic substrate.

Based on the above-mentioned simulation verification results, when the outer contour of the electrode has an arc portion, the minimum spacing d between the electrode and the trace may reach 4 micrometers, and the minimum spacing is the smallest. When the outer contour of the electrode has the sharp portion 210b, the minimum spacing d between the electrode and the trace is required to be greater than or equal to 25 micrometers, and the minimum spacing is the largest. Therefore, for a region with a large wiring space on the microfluidic substrate, the electrode may be of a shape such as a rectangular shape including the sharp portion 210b. With regard to a region with a relatively small wiring space on the microfluidic substrate, the shape of the electrode may be designed as a circular or elliptical shape including an arc portion.

In conjunction with the above-mentioned solutions, when the outer contour of the electrode has the linear portion 210c, the minimum spacing d from the electrode to the traces is not less than 20 micrometers, while the outer contour of the electrode has an arc portion, the minimum spacing d from the electrode to the traces is not less than 4 micrometers. In the related art, some electrodes of a microfluidic substrate are designed to be rectangular, such as a driving electrode, which needs to have a linear portion 210c to drive a droplet to move in a direction perpendicular to the linear portion 210c thereof, so that a minimum spacing d of 20 μm or more is required for the trace runs through one side of the electrode, thereby to effectively protect the electrode. However, it requires sufficient wiring space on the microfluidic substrate, and thus the wiring mode is limited.

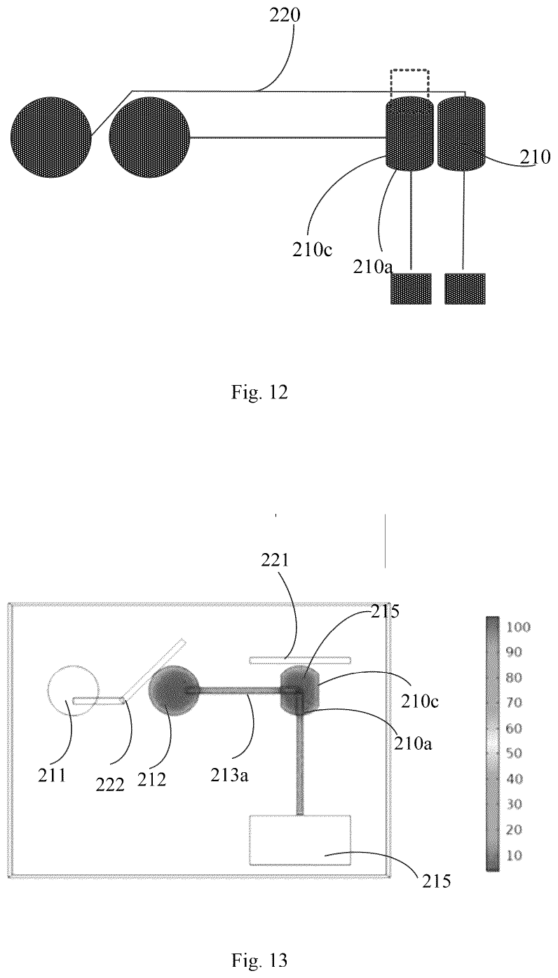

Based on the above, in some embodiments, in order to meet the requirement of more wiring space, as shown in FIG. 12, the shape of the electrode pattern 210 may be designed to include two linear portions 210c and two arc portions 210a, and the corresponding trace pattern 220 passes through one side of one are portion 210a, so that the minimum spacing d (e.g., in a position indicated by a dotted box in the figure) between the trace pattern 220 and the arc portion 210a may be 4 micrometers or more. In some particular embodiments, the electrode having two linear portions 210c and two arc portions 210a may be a driving electrode that drives a droplet.

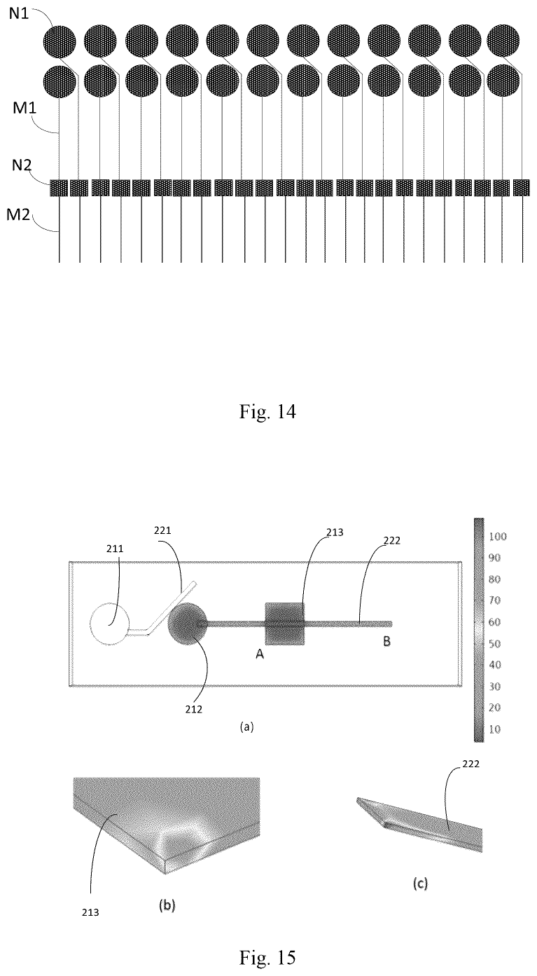

FIG. 13 shows a simulation model for the embodiment of FIG. 12.

As shown in FIG. 13, in the simulation model, the outer contour shape of the electrode includes a linear portion 210c and an arc portion 210a, and the minimum spacing d between at least part of the trace and the arc portion 210a is 4 micrometers. Specifically, as shown in the figure, the electrode pattern 210 may specifically include a first circular electrode 211, a second circular electrode 212, and a special pattern electrode 215 having a linear portion 210c and an arc portion, a first floating trace 221 is arranged adjacent to the arc portion 210a of the special pattern electrode 215, the minimum spacing d between the first floating trace 221 and the arc portion 210a is 4 micrometers. It is assumed that a rectangular outer box in the simulation model shown in the figure is at a zero potential. It is assumed that g the first circular electrode 211 and the second floating trace 222 connected thereto are at a floating potential, and the special pattern electrode 215 is an electrostatic contact discharge area, namely, assuming that static charges are introduced by the special pattern electrode. Air is chosen as a medium.

As shown in FIG. 13, the surface integration Townsend coefficient of the special pattern electrode 215 basically presents a symmetrical distribution along a direction perpendicular to the linear portion 210c thereof, that is to say, the first floating trace 221 has less effect on the electrostatic discharge condition of the special pattern electrode 215, so that the electrode is effectively protected. In this way, it is able to reduce the restrictions on wiring, and notably reduce the wiring spacing, thereby to facilitate the integrated development of the digital microfluidic substrate.

In the embodiments of the present disclosure, the wiring mode of the electrode pattern 210 and the trace pattern 220 on the microfluidic substrate in is improved, so as to effectively protect critical parts and improve the reliability of the microfluidic substrate.

A more detailed description on some specific embodiments of the present disclosure will be given below.

In some embodiments of the present disclosure, as shown in FIGS. 1 and 2, the electrode patterns 210 includes a plurality of first electrodes N1 spaced apart from each other and a plurality of second electrodes N2 spaced apart from each other, the trace patterns 220 include a plurality of first traces M1, and at least one of the first electrodes N1 is coupled to at least one of the second electrodes N2 via a corresponding first trace M1.

Illustratively, at least one first electrode N1 may be a driving electrode used for driving a droplet to move, a plurality of driving electrodes may be arranged sequentially along a predetermined direction, and adjacent driving electrodes are spaced apart from each other, and the predetermined direction is a movement direction of the droplet. At least one first trace M1 is a signal line, at least one second electrode N2 may be a signal terminal electrode for applying an electric signal to the driving electrode, and adjacent signal terminal electrodes are spaced apart from each other and apply the electric signal to the driving electrode through corresponding signal lines. It should be appreciated that the above is only an example, and in practical applications, the first electrode N1 may be not limited to the driving electrode and the second electrode N2 may be not limited to the signal terminal electrode.

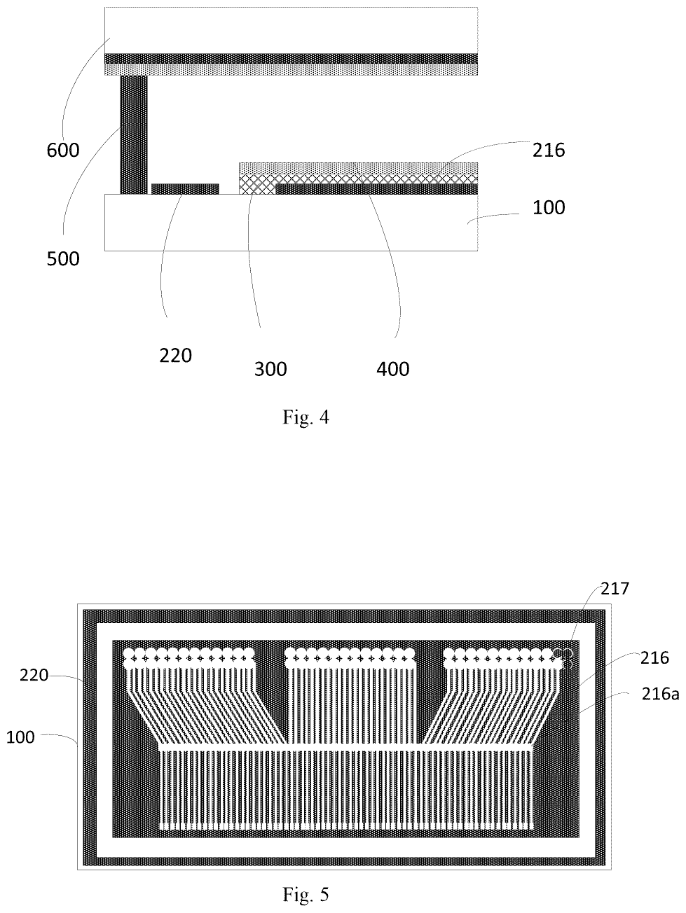

Further, illustratively, as shown in FIGS. 1 to 3, the microfluidic substrate further includes: a dielectric layer 300 covering one side of the conductive layer 200 away from the base substrate 100, and a hydrophobic layer 400 covering one side of the dielectric layer 300 away from the base substrate 100. An orthogonal projection of the hydrophobic layer 400 onto the base substrate 100 coincides with orthogonal projections of the second electrodes N2 onto the base substrate 100, and an orthogonal projection at least a portion of the first electrodes N1 onto the base substrate 100 is located outside orthogonal projections of the dielectric layer 300 and the hydrophobic layer 400 onto the base substrate 100, to enable the at least a portion of the first electrodes to be exposed on a surface of the microfluidic substrate.

On the basis of the above scheme, the microfluidic substrate serves as a substrate of a microfluidic chip, a stack structure thereof may be in a sandwich structure, the conductive layer 200 is located in an interlayer between the base substrate 100 and the dielectric layer 300, and the first electrode N1 may serve as an electrode for applying a signal or grounding to release a charge, and at least a portion of the first electrodes is exposed to the surface of the substrate. The dielectric layer 300 and the hydrophobic layer 400 may be designed by patterning in such a manner as not to cover at least a portion of the first electrodes N1, so that the at least a portion of the first electrodes N1 is exposed to the surface of the substrate. In addition, at least part of the second electrodes N2 may serve as a driving electrode, and the hydrophobic layer 400 covers at least part of the second electrodes N2.

The base substrate 100 may be made of any suitable material such as glass, Polymeric Methyl Methacrylate (PMMA) and Polycarbonate (PC). The conductive layer 200 may be made of any suitable conductive material, such as a metal, for example, molybdenum. In some embodiments, a thickness of the conductive layer 200 may be about 220 nm. The dielectric layer 300 may be made of any suitable organic or inorganic insulating material, for example, the material of the dielectric layer 300 may be selected from silicon nitride, silicon dioxide, polyimide, resin or SU-8 photoresist, etc. In some embodiments, the dielectric layer 300 may have a thickness of about 1 micrometer and a dielectric constant of about 6.5. In some embodiments, the hydrophobic layer 400 may be made of any suitable hydrophobic material, such as Teflon, and may have a thickness of about 100 micrometers.

Further, by way of example, as shown in FIGS. 2 and 14, the trace pattern 220 further includes one or more second traces M2, one end of each second trace M2 is coupled to one of the second electrodes N2, and the other end thereof is a floating end. In this regard, in case that the second trace M2 is not coupled to the second electrode N2, the probability of static charge neutralization occurring at the four corner positions of the second electrode N2 is greater, which undoubtedly increases the risk of damage to the second electrode N2. Therefore, on the basis of the above scheme, the second trace M2 extends from the second electrode N2, the second trace M2 may act as an electrostatic discharge trace, and the probability of electric charges being discharged at a floating end of the second trace M2 is greater, thereby serving to protect the second electrode N2.

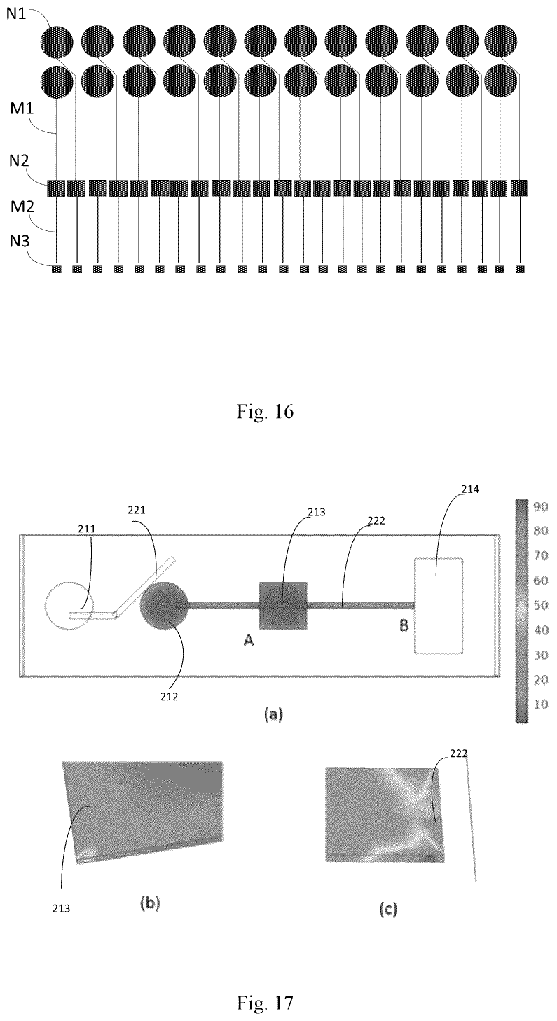

Taking the embodiment shown in FIG. 14 as an example, the electrostatic protection effect of the second trace M2 is verified by simulation. FIG. 15 is a diagram showing a simulation model of the embodiment shown in FIG. 14. In the simulation model shown in Subfigure (a) in FIG. 15, a rectangular outer box is at a zero potential, the electrode patterns 210 include a first circular electrode 211, a second circular electrode 212 (serving as a model of the first electrode N1) and a first rectangular electrode 213 (serving as a model of the second electrode N2), the first circular electrode 211 and a first floating trace 221 connected thereto are each at a floating potential, and one end of the first rectangular electrode 213 is coupled to the second circular electrode 212, and the other end thereof is coupled to a second floating trace 222 (serving as a model of the second trace M2) having a floating end. The first rectangular electrode 213 is provided as an electrostatic contact discharge region. The integration Townsend growth coefficient at point A in Subfigure (a) in FIG. 15 is shown in Subfigure (b) in FIG. 15 and the Townsend growth coefficient at point B in Subfigure (a) in FIG. 15 is shown in Subfigure (c) in FIG. 15. By comparing the integration Townsend growth coefficient at point A with the Townsend growth coefficient at point B, it is derived that the probability of electrostatic breakdown at point B is significantly greater than that at point A. That is, according to the simulation result, the probability of the electrostatic charge being released at the floating end of the second floating trace 222 is relatively high, so as to serve as an effective protection for the electrode. In case that the first rectangular electrode 213 is not coupled to the second trace M2, there is a greater probability of static charge neutralization at the four corner positions of the first rectangular electrode 213, resulting in an increased risk of damage to the first rectangular electrode 213.

In other embodiments of the present disclosure, by way of example, as shown in FIG. 12, the electrode patterns 210 may further include one or more third electrodes N3 each located at one side of the floating end and spaced apart from the floating end.

In this way, the third electrode N3 is spaced apart from the floating end of the second trace M2, and may serve as an electrostatic discharge point, and, illustratively, a distance between the floating end and the third electrode N3 is less than or equal to 20 micrometers.

Take the embodiment shown in FIG. 16 as an example, the electrostatic protection effect of the third electrode N3 was verified by simulation. FIG. 17 is a diagram showing a simulation model of the embodiment shown in FIG. 16. In the model shown in Subfigure (a) in FIG. 17, a rectangular outer box is at a zero potential. As compared with the simulation model shown in FIG. 15, the second rectangular electrode 214 (which is a model of the third electrode) is added to the floating end of the second floating trace 222, and a distance between the second rectangular electrode 214 and the floating end is less than or equal to 20 micrometers. Similarly, it is assumed that static charges are introduced by the first rectangular electrode 213. The integration Thomson growth coefficient at point A in Subfigure (a) in FIG. 17 is shown in Subfigure (b) in FIG. 17 and the Thomson growth coefficient at point B in Subfigure (a) in FIG. 17 is shown in Subfigure (c) in FIG. 17. By comparing the integration Townsend growth coefficient at point A with the Townsend growth coefficient at point B, it is derived that the probability of electrostatic breakdown at point B is significantly greater than that at point A. That is to say, according to the simulation result, after adding the second rectangular electrode 214 (namely, the third electrode N3), the probability of electrostatic charge neutralization occurring at the second rectangular electrode 214 further increases, thereby further reducing the probability of electrostatic charge neutralization occurring at the four corners of the first rectangular electrode 213.

In some exemplary embodiments, it may be preferred that the spacing between the second trace M2 and the floating end is within 10 micrometers. Illustratively, the third electrode N3 may have a size of 1 mm*0.5 mm and may be spaced apart from the floating end of the second trace M2 by a distance of 4 micrometers. The size of the third electrode N3 may be designed according to practical requirements, but it is required to ensure that a length of a side edge of the third electrode N3 directly facing the second trace M2 is greater than a line width of the second trace M2, i.e., in a direction of the line width of the second trace M2, the length of the side edge of the third electrode N3 opposite to the floating end is greater than the line width of the second trace M2. Furthermore, the third electrodes N3 are spaced apart from each other.

Furthermore, in some exemplary embodiments, as shown in FIGS. 1-2 and 4, the microfluidic substrate further includes a middle region (AA region) and a peripheral region located at a periphery of the middle region, and the one or more electrode patterns 210 and the one or more trace patterns 220 are located within the middle region. The patterns of the conductive layer 200 further include an outer-charge shielding region 230 located at the peripheral region to surround the middle region. Illustratively, a distance between the outer-charge shielding region 230 and a peripheral edge of the base substrate 100 is greater than or equal to 5 mm.

On the basis of the above scheme, through the outer-charge shielding region 230 in the peripheral region, it is able to enable external charges to be neutralized before entering an interior of the chip, so as to avoid the functional failure of the device due to that the external charges enter the critical part of the middle region, thereby improving the yield of the microfluidic substrate, improving the reliability of the microfluidic chip at the application end and reducing the manufacturing cost of the microfluidic chip.

Note that the conductive layer 200 may be one layer, and in practical applications, the conductive layer 200 may also be a plurality of layers. In order to ensure that the outer-charge shielding region 230 effectively prevents external charges from entering the middle region to protect the electrode pattern 210 and the trace pattern 220, the electrode pattern 210, the trace pattern 220 and the outer-charge shielding region 230 are preferably arranged at a same layer.

In some embodiments, as shown in FIG. 2, the outer-charge shielding region 230 may be a rectangular annular region, and have a width of about 2 mm. When the microfluidic substrate is applied in a microfluidic chip and arranged opposite to another substrate 600 to form a cell, peripheries of are fixedly connected to each other via a sealant 500, and a distance between an outer edge of the outer-charge shielding region 230 and the sealant 500 is greater than or equal to 100 micrometers. It should be appreciated that the above data are preferred, but are not limited thereto, and that in a practical design, it is necessary to ensure that the distance between the outer peripheral edge of the outer-charge shielding region and the peripheral edge of the base substrate 100 is greater than or equal to 5 mm, so as to avoid contact electrostatic discharge of external charges.

Furthermore, in some exemplary embodiments, as shown in FIG. 2, the patterns of the conductive layer 200 further include a charge neutralization region 240, an orthogonal projection of the charge neutralization region 240 onto the base substrate 100 is located in the middle region and has a spacing with an orthogonal projection of the outer-charge shielding region 230 onto the base substrate 100, the charge neutralization region 240 includes a covering portion 241 and an opening portion 242, and a pattern of at least a partial region of the opening portion 242 has a same shape as at least one electrode pattern 210 and at least one trace pattern 220, and the covering portion 241 covers at least an area in the middle region other than the one or more electrode patterns 210 and the one or more trace patterns 220, and the covering portion 241 is insulated from at least a portion of the electrode patterns 210 and the trace patterns 220.

On the basis of the above scheme, the charges entering the interior of the microfluidic substrate may be neutralized by the charge neutralization region 240, so as to protect critical parts such as the electrode patterns 210 and the trace patterns 220. As shown in FIG. 2, the charge neutralization region 240 has a substantially rectangular shape and is designed with a hollowed-out pattern, i.e. the opening portion 242, a shape of the hollowed-out pattern may be determined by each electrode pattern 210 and each trace pattern 220 on the conductive layer 200. Preferably, the charge neutralization region 240 is arranged at a same layer as the electrode pattern 210 and the trace pattern 220.

Further, by way of example, the covering portion 241 is spaced apart from the electrode patterns 210 and the trace patterns 220 that are insulated from the covering portion by a distance of greater than or equal to 25 micrometers. In this way, a signal to the electrode pattern 210 and the trace pattern 220 is prevented from being adversely affected or the electrostatic breakdown phenomenon is prevented.

Illustratively, the orthogonal projection of the charge neutralization region 240 onto the base substrate is spaced apart from the orthogonal projection of the outer-charge shielding region 230 onto the base substrate 100 by a distance of greater than or equal to 20 micrometers. In this way, it is able to avoid that the charge neutralization region 240 is adversely affected by the outer-charge shielding region 230.

Further, by way of example, as shown in FIG. 2, the electrode patterns 210 further includes a plurality of fourth electrodes N4 arranged in a floating manner, the charge neutralization region 240 is electrically connected to at least one of the fourth electrodes N4, and at least a part of the fourth electrodes N4 is exposed to a surface of the microfluidic substrate.

On the basis of the above scheme, the conductive layer 200 is further designed to have the fourth electrode N4 exposed on the surface of the substrate and arranged in the floating manner, the fourth electrode N4 is different from, and insulated from, the first electrode N1 and second electrode N2, and is electrically connected to the charge neutralization region 240, so that charges on the charge neutralization region 240 are released through the fourth electrode N4 during the use of the microfluidic substrate.

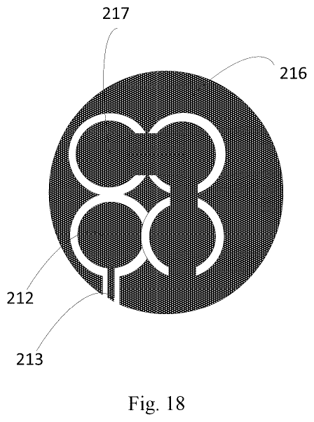

In some embodiments, the greater the cases that the charge neutralization region 240 is electrically connected to the fourth electrode N4, the greater the probability of that the charges being released through the fourth electrode N4, and therefore, the quantity of the fourth electrodes N4 is preferably greater than or equal to 2. In an example shown in FIG. 18, the quantity of the fourth electrodes N4 is three.

Preferably, the fourth electrode N4 may be arranged in a region adjacent to the first electrode N1 and located near a corner of the middle region of the entire base substrate 100 (a region indicated by a dashed box B in FIG. 2). In this way, it is able to prevent the function of other functional electrodes or traces, as well as wiring space from being adversely affected.

The above-mentioned charge neutralization region 240 is a conductive structure having a large area, so when an external electrostatic charge is randomly released on the surface of the microfluidic substrate, the charge neutralization region 240 may provide a large quantity of free electrons to neutralize the external charge. In a non-contact mode test, it is able to improve the anti-static breakdown performance of the microfluidic substrate by about 20% (an average breakdown voltage of the microfluidic substrate is increased from 8.9 kV to 10.8 kV) by setting the charge neutralization region 240.

In the microfluidic substrate of the present disclosure, the wiring manner of the electrodes and traces is improved, the outer-charge shielding region 230, the charge neutralization region 240 and the second trace M2, a third electrode N3, etc. serving the function of electrostatic discharge are provided, so as to neutralize the electrostatic charges and discharge the static charges at a fixed position, thereby to achieve the protection of the critical parts, prevent the electrostatic breakdown of the critical parts and avoid the functional failure of the device caused by the electrostatic discharge.

In addition, the embodiments of the present disclosure further provide a microfluidic chip, including a first substrate and a second substrate arranged opposite to each other to form a cell, a sample flow channel is formed between the first substrate and the second substrate, and the microfluidic substrate in the embodiments of the present disclosure is used as the first substrate.

The embodiments of the present disclosure further provide an assay device including the microfluidic chip in the embodiments of the present disclosure. The assay device may be applied to various fields such as physics, chemistry, biology, medicine, etc. For example, when applied to the medical field, it may screen and analyze human blood cells, etc.

Some descriptions will be given as follows.

(1) The drawings merely relate to structures involved in the embodiments of the present disclosure, and the other structures may refer to those known in the art.

(2) For clarification, in the drawings for describing the embodiments of the present disclosure, a thickness of a layer or region is zoomed out or in, i.e., these drawings are not provided in accordance with an actual scale. It should be appreciated that, in the case that such an element as layer, film, region or substrate is arranged “o” or “under” another element, it may be directly arranged “on” or “under” the other element, or an intermediate element may be arranged therebetween.

(3) In the case of no conflict, the embodiments of the present disclosure and the features therein may be combined to acquire new embodiments.

The above embodiments are merely for illustrative purposes, but shall not be construed as limiting the scope of the present disclosure. The scope of the present disclosure shall be subject to the scope defined by the appended claims.

1. A microfluidic substrate, comprising:
a base substrate; and
a conductive layer arranged on the base substrate, wherein patterns of the conductive layer comprise one or more electrode patterns and one or more trace patterns;
wherein an orthogonal projection of at least a portion of each trace pattern onto the base substrate is on one side of an orthogonal projection of a corresponding electrode pattern onto the base substrate with a minimum spacing of greater than or equal to 4 micrometers from an outer contour of the corresponding electrode pattern.

2. The microfluidic substrate according to claim 1, wherein
an outer contour of each of at least a portion of the electrode patterns comprises an arc portion, and a minimum spacing between an orthogonal projection of at least a portion of a corresponding trace pattern onto the base substrate and an orthogonal projection of the arc portion onto the base substrate is greater than or equal to 4 micrometers.

3. The microfluidic substrate according to claim 1, wherein
the electrode patterns comprise a plurality of first electrodes spaced apart from each other and a plurality of second electrodes spaced apart from each other, wherein the trace patterns comprise a plurality of first traces, at least one of the first electrodes is coupled to at least one of the second electrodes via a corresponding one of the first traces.

4. The microfluidic substrate according to claim 3, further comprising:
a dielectric layer covering one side of the conductive layer away from the base substrate;
a hydrophobic layer covering one side of the dielectric layer away from the base substrate;
wherein an orthogonal projection of the hydrophobic layer onto the base substrate coincides with orthogonal projections of the second electrodes onto the base substrate, and an orthogonal projection of at least a portion of the first electrodes onto the base substrate is located outside orthogonal projections of the dielectric layer and the hydrophobic layer onto the base substrate, to enable the at least a portion of the first electrodes to be exposed to a surface of the microfluidic substrate.

5. The microfluidic substrate according to claim 4, wherein the trace patterns further comprise one or more second traces, one end of each second trace is coupled to one of the second electrodes, and the other end thereof is a floating end.

6. The microfluidic substrate according to claim 5, wherein the electrode patterns further comprise one or more third electrodes each located on one side of and spaced apart from the floating end.

7. The microfluidic substrate according to claim 6, wherein the floating end is spaced apart from the third electrode by less than or equal to 20 micrometers.

8. The microfluidic substrate according to claim 1, further comprising a middle region and a peripheral region located at a periphery of the middle region, and the one or more electrode patterns and the one or more trace patterns are located in the middle region; the patterns of the conductive layer further comprise an outer-charge shielding region located at the peripheral region to surround the middle region.

9. The microfluidic substrate according to claim 8, wherein a distance between the outer-charge shielding region and a peripheral edge of the base substrate is greater than or equal to 5 mm.

10. The microfluidic substrate according to claim 9, wherein the patterns of the conductive layer further comprise a charge neutralization region, an orthogonal projection of the charge neutralization region onto the base substrate is located in the middle region with a spacing from an orthogonal projection of the outer-charge shielding region onto the base substrate, the charge neutralization region comprises a covering portion and an opening portion, a pattern of at least a part of the opening portion has a same shape as at least one electrode pattern and at least one trace pattern, and the covering portion covers at least an area in the middle region except the one or more electrode patterns and the one or more trace patterns, and the covering portion is insulated from at least a portion of the electrode patterns and the trace patterns.

11. The microfluidic substrate according to claim 10, wherein the covering portion is spaced apart from the electrode patterns and the trace patterns that are insulated from the covering portion by a distance of greater than or equal to 25 micrometers.

12. The microfluidic substrate according to claim 10, wherein the orthogonal projection of the charge neutralization region onto the base substrate is spaced apart from the orthogonal projection of the outer-charge shielding region onto the base substrate by a distance of greater than or equal to 20 micrometers.

13. The microfluidic substrate according to claim 10, wherein the electrode patterns further comprise a plurality of fourth electrodes disposed in a floating manner, the charge neutralization region is electrically connected to at least one of the fourth electrodes, and at least a part of the fourth electrodes is exposed to a surface of the microfluidic substrate.

14. The microfluidic substrate according to claim 3, wherein
at least one first electrode is a driving electrode for driving a droplet to move;
at least one second electrode is a signal terminal electrode for applying an electric signal to the driving electrode.

15. A microfluidic chip, comprising a first substrate and a second substrate arranged opposite to each other to form a cell, wherein a sample flow channel is formed between the first substrate and the second substrate; wherein the microfluidic substrate according to claim 1 is used as the first substrate.

16. An assay device comprising the microfluidic chip of claim 15.

17. The microfluidic substrate according to claim 1, wherein an outer contour of each of at least a portion of the electrode patterns comprises a sharp portion, and a minimum spacing between an orthogonal projection of at least a portion of a corresponding trace pattern onto the base substrate and an orthogonal projection of the sharp portion onto the base substrate is greater than or equal to 25 micrometers.

18. The microfluidic substrate according to claim 1, an outer contour of each of at least a portion of the electrode patterns comprises a linear portion, and a minimum spacing between an orthogonal projection of at least a portion of a corresponding trace pattern onto the base substrate and an orthogonal projection of the linear portion onto the base substrate is greater than or equal to 20 micrometers.

19. The microfluidic chip according to claim 15, wherein an outer contour of each of at least a portion of the electrode patterns comprises an arc portion, and a minimum spacing between an orthogonal projection of at least a portion of a corresponding trace pattern onto the base substrate and an orthogonal projection of the arc portion onto the base substrate is greater than or equal to 4 micrometers.

20. The microfluidic chip according to claim 15, wherein an outer contour of each of at least a portion of the electrode patterns comprises a sharp portion, and a minimum spacing between an orthogonal projection of at least a portion of a corresponding trace pattern onto the base substrate and an orthogonal projection of the sharp portion onto the base substrate is greater than or equal to 25 micrometers.
